(19) United States
(12) Patent Application Publication
(10) Pub. No.: US 2026/0179212 A1
(43) Pub. Date: Jun. 25, 2026

(54) PRINT VELOCITY-BASED SCANNED IMAGE CORRECTION

(71) Applicants: Hewlett-Packard Development Company, L.P., Spring, TX (US); Purdue Research Foundation, West Lafayette, IN (US)

(72) Inventors: Runzhe ZHANG, West Lafayette, IN (US); Yeri NAM, Seongnam Si (KR); Ki-Youn LEE, Seongnam Si (KR); Yousun BANG, Seongnam Si (KR); Mark Q. SHAW, Boise, ID (US); Jan Philip ALLEBACH, West Lafayette, IN (US)

(21) Appl. No.: 19/125,952

(22) PCT Filed: Oct. 31, 2022
(86) PCT No.: PCT/US2022/048426

§ 371 Date: Apr. 30, 2025

(51) Int. Cl. G06T 7/00; G06T 5/20

(52) U.S. Cl. CPC G06T 7/001; G06T 5/20; G06T 7/0004; H04N 2201/0082

(57) ABSTRACT

An original image and a scanned image of a printed hardcopy of the original image are received. Each of the original image and the scanned image has a number of horizontal lines. The original image is printed by print hardware at a varying print velocity to generate the printed hardcopy. The printed hardcopy is scanned by scan hardware in-line with the print hardware at a constant scan rate to generate the scanned image. The scanned image is corrected, based on a print velocity at which the original image was printed that is estimated for each horizontal line of the scanned image.

### BACKGROUND

A printing device can include print hardware as well as scan hardware. The print hardware may use a variety of different technologies, including inkjet-printing and laser-printing technologies, among others, to print a hardcopy of an original image, such as on a media sheet like paper. The scan hardware may also use a variety of technologies, including charged-coupled device (CCD) and contact-image scanner (CIS) technologies, among others, to scan a scanned image of the printed hardcopy of the original image.

### BRIEF DESCRIPTION OF THE DRAWINGS

FIG. 1A is diagram of a printing device having print hardware and scan hardware in-line with the print hardware.

FIG. 1B is a diagram of an example image having pixels organized along rows and columns.

FIGS. 1C, 1D, and 1E are diagrams of different example original images that can be printed to generate hardcopies, which can then be scanned to generate scanned images.

FIGS. 2A, 2B, and 2C are diagrams of an example original image printed to at a varying print velocity to generate a hardcopy, and an example scan image generated by scanning the hardcopy at a constant scan rate.

FIG. 3 is a flowchart of an example process to identify and resolve print defects based on a scanned image of a printed hardcopy of an original image, where the scanned image is corrected based on an estimated print velocity at which the original image was printed for each horizontal line of the scanned image.

FIG. 4 is a flowchart of an example process applicable to any type of original image to estimate a print velocity at which the original image was printed for each horizontal line of a scanned image, where the horizontal lines correspond to pixel rows.

FIGS. 5A and 5B are example matrices generated in performance of the process of FIG. 4.

FIG. 6 is a diagram of example original and scanned images having equal numbers of intervals, where each interval encompasses multiple pixel rows corresponding to a line of text or to whitespace between adjacent lines of text.

FIG. 7 is a flowchart of an example process applicable to an original image having at least lines of text to estimate a print velocity at which the original image was printed for each horizontal line of a scanned image, where the horizontal lines correspond to intervals that each encompass multiple pixel rows corresponding to a line of text or to whitespace between adjacent lines of text.

FIG. 8 is a diagram of an example non-transitory computer-readable data storage medium.

FIG. 9 is a diagram of an example electronic device.

FIG. 10 is a flowchart of an example method.

### DETAILED DESCRIPTION

As noted in the background, a printing device can include print hardware as well as scan hardware. The scan hardware may be in-line with the print hardware. Therefore, as the print hardware prints the original image to generate a hardcopy of the original image, the scan hardware can scan the printed hardcopy to generate a scanned image corresponding to the original image. The scanned image may be compared to the original image to identify print defects that can then be resolved to improve print quality.

The print hardware may print at a varying, or variable, print velocity, or print speed. This means that some horizontal lines of the original image, such as rows of pixels, may be printed more slowly or more quickly than other horizontal lines (e.g., rows of pixels). By comparison, the scan hardware may scan the printed hardcopy at a constant scan rate to generate a scanned image that also has horizontal lines, such as rows of pixels. When the print velocity is equal to the constant scan rate, a row of pixels in the original image has a single corresponding row of pixels in the scanned image.

However, when the print velocity is less than the constant scan rate, a row of pixels in the original image may have multiple corresponding rows of pixels in the scanned image. In one case, when the print velocity is greater than the constant scan rate, a row of pixels of the original image may not have any corresponding rows of pixels in the scanned image. In another case, when the print velocity is greater than the constant scan rate, rows of pixels of the original image may effectively be compressed in the scanned image. For instance, three rows of pixels of the original image may correspond to one or two rows of pixels in the scanned image. Different rows of pixels of the original image may be printed at different print velocities, resulting in a scanned image having rows of pixels that do not have one-to-one correspondence with the horizontal lines of the original image.

Prior to comparison of the scanned image to the original image to identify print defects that can then be resolved to improve print quality, the scanned image has to be corrected to remove duplicative rows of pixels from the scanned image and add omitted rows of pixels to the scanned image. Horizontal lines are duplicative if more than one row of pixels in the scanned image corresponds to the same row of pixels in the original image. A row of pixels is omitted if there is no row of pixels in the scanned image that corresponds to the row of pixels in the original image.

Usually a test or calibration image is printed as the original image so that the print velocity at which the image was printed can be estimated for each row of pixels of the scanned image. Requiring usage of a test or calibration image is at best inconvenient for users of a printing device. Significant time may also elapse after a test or calibration image has been printed and the next time it is printed. Print defects that first occur within this time period will not be identified—and thus their causing issues may not be able to resolved—until the next time the test or calibration image is printed.

Techniques described herein ameliorate these and other issues. The techniques map horizontal lines of an original image to horizontal lines of a scanned image of a printed hardcopy of the scanned image. The techniques include a generalized approach for estimating print velocity at which the original image was printed for each horizontal line of the scanned image, which is applicable to original images including only graphical content, only text content, or both graphical and text content.

The techniques further include a text-oriented approach for estimating print velocity at which the original image was printed for each horizontal line of the scanned image, which is applicable to original images including only text content, or both graphical and text content. Testing of the described techniques has demonstrated that they can accurately estimate print velocity even for original images including user-generated content. That is, a test or calibration that is specially constructed for estimating print velocity estimation is not required.

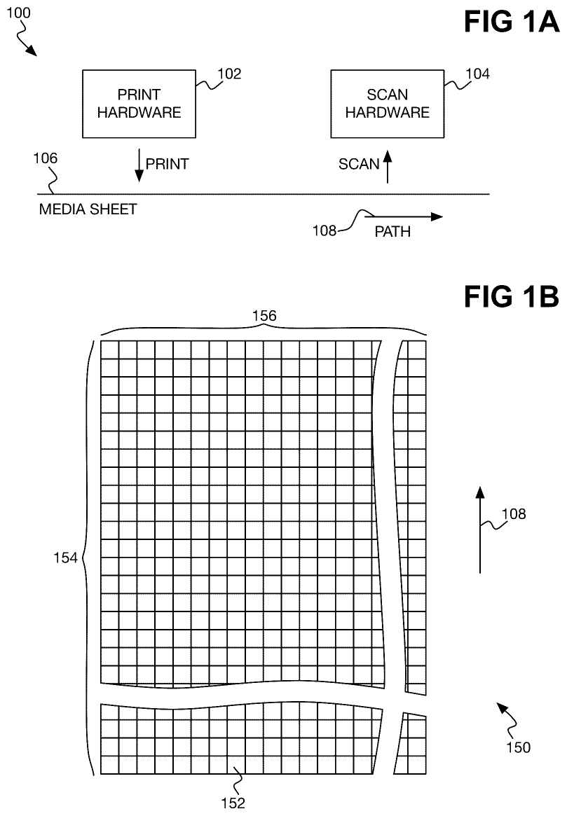

FIG. 1A shows an example printing device 100. The printing device 100 can also be referred to as a printer. The printing device 100 includes print hardware 102, which may also be referred to as or which may include a print circuit, and scan hardware 104, which may also be referred to as or which may include a scan circuit. The scan hardware 104 is in-line with and downstream from the scan hardware 104 along a media path 108. The print hardware 102 thus prints on a media sheet 106, such as a sheet of paper, and then the scan hardware 104 scans the sheet 106 as has been printed on, as and when the media sheet 106 advances along the media path 108.

In the depicted example, the print path 108 is depicted as being a straight path from left to right, as may be the case in an implementation in which the print hardware 102 is or includes inkjet-printing hardware. Such inkjet-printing hardware may include a stationary print bar array of inkjet printheads or a scanning carriage of inkjet printheads. The print path 108 may instead be more serpentine, as may be the case in an implementation in which the print hardware 102 is or includes laser-printing hardware. In either case, the scan hardware 104 is still in-line with (and downstream from) the print hardware 102 along the media path 108.

The print hardware 102 prints at a variable print velocity, such that that the print velocity at which an original image is printed can vary with different portions of the image. As an example, portions of the image requiring more toner, ink, or other colorant to achieve printing may result in a lower print velocity as compared to portions of the image requiring less colorant. As another example, portions of the image that are empty—and thus do not require any colorant—may result in a fastest print velocity. By comparison, however, the scan hardware 104 scans at a constant scan rate, which may be less than, greater than, or equal to (i.e., correspond to) the current print velocity.

FIG. 1B shows an example image 150. The image 150 may be an original image that is printed by the print hardware 102 to generate a printed hardcopy of the original image, or may be a scanned image that is generated by the scan hardware 104 scanning the printed hardcopy of the original image. The image 150 includes pixels 152 organized over rows 154 and columns 156. The rows 154 run from top to bottom over the media path 108 along which the media sheet 106 advances from the print hardware 102 to the scan hardware 104.

Therefore, the columns 156 of a given row 154 of pixels 152 are first printed by the print hardware 102 (either simultaneously or not), and then scanned by the scan hardware 104. For example, in the case in which the print hardware 102 is laser-printing hardware or includes a stationary print bar array of inkjet printheads, the print hardware 102 may simultaneously print the columns 156 of a given row 154 of pixels 152. In the case in which the print hardware 102 includes a scanning carriage of one or multiple inkjet printheads, the print hardware 102 may scan across the columns 156 of a given row 154 (or rows 154) of pixels 152.

In the case of a full-color image 150, each pixel 152 can include values for a number of color components of a color space, such as red, green, and blue values in the case of the red-green-blue (RGB) color space. The color of a pixel 152 is thus defined by these values. In the case of a grayscale image 150, each pixel 152 includes a value for a single color component, from a minimum value corresponding to black (or conversely to white) to a maximum value corresponding to white (or conversely to black).

FIGS. 1C, 1D, and 1E show different examples of an original image 200 that the print hardware 102 can print. In FIG. 1C, the original image 200 includes only one or multiple graphical content portions 162, and does not include any text. In FIG. 1D, the image 200 includes only lines of text 164 with whitespace 166 between adjacent lines. The whitespace 166 can correspond to nothing to be printed by the print hardware 102, or to a background color or shade of gray against which the lines of text 164 are visible. In FIG. 1E, the image 200 includes both one or multiple graphical content portions 162, as well as lines of text 164 with whitespace 166 between adjacent lines.

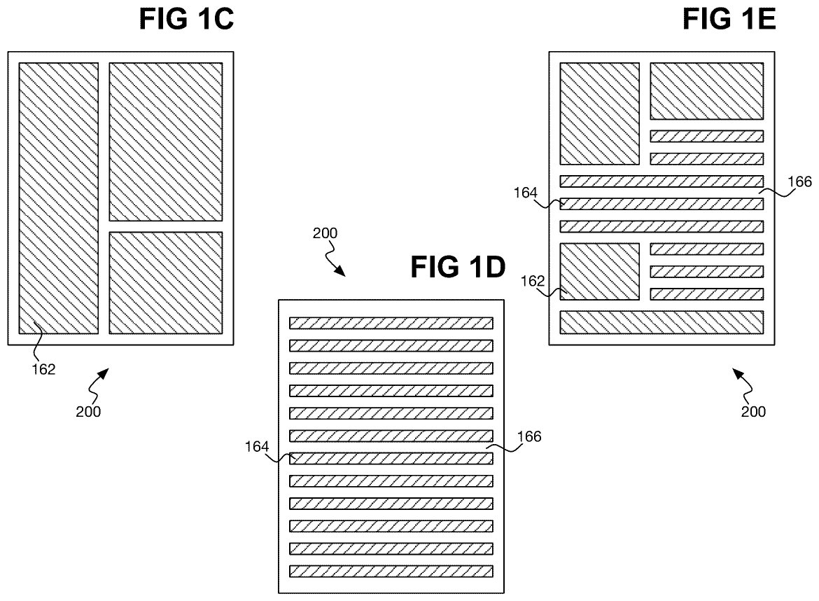

FIGS. 2A, 2B, and 2C show an example original image 200 and a corresponding scanned image 202. The original image 200 includes horizontal lines 204A, 204B, and 204C in FIG. 2A, horizontal lines 208A and 208B in FIG. 2B, and horizontal lines 209A, 209B, 209C, and 209D in FIG. 2C The scanned image 202 includes horizontal lines 206A, 206B, and 206C in FIG. 2A; 210A, 210B, 210C, 210D, and 210E in FIG. 2B; and horizontal lines 212A and 212B in FIG. 2C.

Each horizontal line can be a row 154 of pixels 152. In another implementation, each horizontal line can be an interval encompassing multiple rows 154 of pixels 152 that correspond to a line of text 164 or whitespace 166 between adjacent lines of text 164. The remaining description of FIGS. 2A, 2B, and 2C pertains to the case in which the horizontal lines are each a row 154 of pixels 152, for descriptive clarity and convenience.

In FIG. 2A, the horizontal lines 204A, 204B, and 204C of the original image 200 respectively correspond to the horizontal lines 206A, 206B, and 206C of the scanned image 202. This means that when the printed hardcopy of the horizontal lines 204A, 204B, and 204C of the original image 200 was being scanned by the scan hardware 104 in generating the horizontal lines 206A, 206B, and 206C of the scanned image 202, the print velocity at which the print hardware 102 was printing the original image 200 was equal to the constant scan rate. That is, the horizontal lines 204A, 204B, and 204C were scanned once, as the horizontals line 206A, 206B, and 206C, respectively.

In FIG. 2B, the horizontal line 208A of the original image 200 corresponds to both the horizontal lines 210A and 210B of the scanned image 202. This means that when the printed hardcopy of the horizontal line 208A of the original image 200 was being scanned by the scan hardware 104 in generating the horizontal lines 210A and 210B of the scanned image 202, the print velocity at which the print hardware 102 was printing the original image 200 was slower than (and specifically equal to half of) the constant scan rate. That is, the horizontal line 208A was scanned twice, as the horizontal line 210A and as the horizontal line 210B.

In FIG. 2B, the horizontal line 208B of the original image 200 corresponds to three horizontal lines 210C, 210D, and 210E of the scanned image 202. This similarly means that when the printed hardcopy of the original image 200 was being scanned by the scan hardware 104 in generating the horizontal lines 210C, 210D, and 210E of the scanned image 202, the print velocity at which the print hardware 102 was printing the original image 200 was even slower than (and specifically equal to one third of) the constant scan rate. That is, the horizontal line 208B was scanned three times, as the horizontal line 210C, as the horizontal line 210D, and as the horizontal line 210D.

In FIG. 2C, the horizontal lines 209A and 209D of the original image 200 can be considered in one implementation as respectively corresponding to the horizontal lines 212A and 212B of the scanned image 202, as depicted. In this case, the horizontal lines 209B and 209C of the original image 200 between the horizontal lines 209A and 209C do not correspond to any horizontal line in the scanned image 202. This means that between the printed hardcopy of the original image 200 being scanned by the scan hardware 104 in generating the horizontal line 212A and being scanned in generating the horizontal line 212B, the print velocity at which the print hardware 102 was printing was greater than (and specifically equal to three times of) the constant scan rate. That is, the horizontal lines 209B and 209C were not scanned.

In another implementation, because the print velocity at which the print hardware 102 was printing when the printed hardcopy of the original image 200 was being scanned to generate the horizontal lines 212A and 212B, the horizontal lines 212A and 212B can both correspond to all of the horizontal lines 209A, 209B, 209C, and 209D. That is, in this case, the information in the horizontal lines 209A, 209B, 209C, and 209D is included in the horizontal lines 212A and 212B. Therefore, it can be said that horizontal lines 209A, 209B, 209C, and 209D match horizontal lines 212A and 212B.

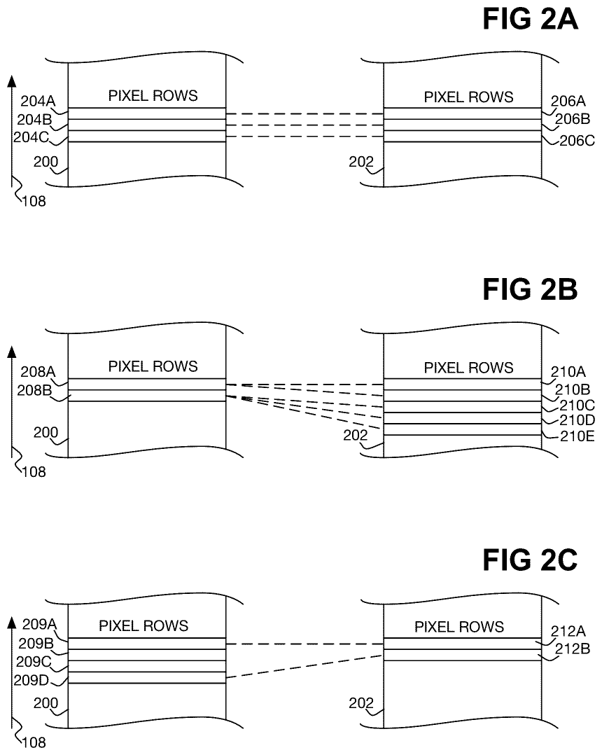

FIG. 3 shows an example process 300 in which estimated print velocity at which an original image 200 was being printed when a corresponding scanned image 202 was being generated is used to identify print quality defects that can then be resolved. The original image 200 is printed (302) by the print hardware 102 to generate a hardcopy 304. As the hardcopy 304 is being generated, the hardcopy 304 is scanned (306) by the scan hardware 104 in-line with and downstream from the print hardware 102 to generate the scanned image 202.

The original image 200 and the scanned image 202 respectively have horizontal lines 308 and 310. As noted, the horizontal lines 308 and 310 can correspond to individual rows 154 of pixels 152, or to intervals that encompass multiple rows 154 of pixels 152 constituting lines of text 164 or whitespace 166 between adjacent lines of text 164. There may be fewer or greater horizontal lines 308 in the original image 200 as compared to horizontal lines 310 in the scanned image, or equal numbers of horizontal lines 308 in the original image 200 and horizontal lines 310 in the scanned image 202.

The horizontal lines 308 of the original image 200 are mapped (312) to the horizontal lines 310 of the scanned image 202. Each horizontal line 308 of the original image 200 can be mapped to zero, one, or more than one horizontal line 310 in the scanned image 202, per FIGS. 2A, 2B, and 2C as have been described. Furthermore, the same horizontal line 310 of the scanned image 202 may be mapped to multiple horizontal lines 308 in the original image 200 as well.

For each horizontal line 310 of the scanned image 202, the print velocity 314 at which the original image 200 was being printed when the hardcopy 304 was being scanned to generate the horizontal line 310 in question is estimated (316). Different techniques for mapping the horizontal lines 308 to the horizontal lines 310 and for estimating the print velocity for each horizontal line 310 of the scanned image 202 are described later in the detailed description.

The scanned image 202 is corrected (318) based on print velocity 314 that has been estimated for each horizontal line 310 of the scanned image 202. This can mean that if a row of pixels in the original image 200 is duplicated more than once in the scanned image 202, the redundant rows can in effect be removed from the scanned image 202. This can also or instead mean that if a row of pixels in the original image 200 is missing from (i.e., omitted in) the scanned image 202, the row can in effect be added to the scanned image 202.

Correction of the scanned image 202 can thus effectively include compensating for either or both of redundant rows of pixels and missing rows of pixels within the scanned image 202. Such correction is based on the estimated print velocity 314 for each horizontal line 310 of the scanned image 202 in that the pixel rows of the scanned image 202 can be interpolated based on their respective estimated print velocities. For example, a pixel row having an estimated print velocity normalized to one (meaning that the estimated print velocity is equal to the constant scan rate) in the scanned image 202 has a full corresponding pixel row in the corrected scanned image 202.

By comparison, a pixel row having an estimated print velocity normalized to less than one (meaning that the estimated print velocity is slower than the constant scan rate) has a corresponding fractional pixel row in the corrected scanned image 202, where this fraction is equal to the estimated print velocity and is less than one. For example, if the estimated print velocity is 0.5, then the pixel row in the scanned image 202 is used to generate just a half of a pixel row in the corrected scanned image 202.

A pixel row having an estimated print velocity normalized to greater than one (meaning that the estimated print velocity is greater than the constant scan rate) has at least one full corresponding print row and potentially a fractional print row in the corrected scanned image. For example, if the estimated print velocity is 1.5, then the pixel row in the scanned image 202 has 1.5 pixel rows in the corrected scan image 202, generated based on the pixel row in question and potentially adjacent pixel rows.

Print quality defects 322 within the hardcopy 304 can then be identified (324) based on a comparison of the original image 200 that was printed and the corrected scanned image 202 of the hardcopy 304. The print quality defects 322 can constitute differences between the original image 200 and the corrected scanned image 202. Such differences may be analyzed in different ways in order to categorize them. As an example, banding defects include Dark-Light Zone Banding (DLZB), which is a smooth banding that appears in multi-pass print modes due to changing print medium conditions as the passes progress.

As a second example, another type of banding defect that can occur can be a periodic banding defect. For instance, in the case in which the print hardware 102 is laser-printing hardware, the hardware 102 may include an optical photoconductor (OPC) in the form of a drum or cylinder. A defect in a certain portion of the drum will result in an artifact in the printed hardcopy 304 each time that drum portion is used to print a part of the original image 202. This means that the artifact will repeat at a constant period in the hardcopy 304. For the banding defect to be properly detected in the scanned image 202, the scanned image 202 has to have the same vertical geometry as the original image 200, so that the artifact is repeated at a constant period within the scanned image 202.

As a third example, the print quality defects 322 can include image artifacts associated with the failure of a toner cartridge or the print hardware 102 itself (e.g., the OPC, the fuser, or the developer roller) in the case in which the print hardware 102 is laser-printing hardware. Colors present in the original image 200 but absent in the corrected scanned image 202 can mean that the colorant supply (e.g., toner or ink cartridge) has been exhausted. An overall quality metric as to how well the corrected scanned image 202 represents the original image 200 may be used to assess the print quality defects 322 as well.

A remedial (e.g., corrective or resolution) action 326 can then be performed in relation to the print hardware 102 (328) to resolve the print quality defects 322. As one example, print quality defects 322 that are associated with failing particular print hardware 102 or colorant cartridges used by the hardware 102 can be resolved by replacement as the remedial action 326. Similarly, print quality defects 322 associated with missing colors may be resolved by replacement of the inkjet or toner cartridges of or including that color as the remedial action.

As another example, an overall quality metric indicating that that the corrected scanned image 202 is representative of the original image 200 by less than a threshold may be resolved automatically, such as by changing print settings or by recalibration of the print hardware 102 as the remedial action. For instance, a higher quality print setting may be selected so that reprinting results in the scanned image 202 better representing the original image 200. As another example, color or other calibration of the print hardware 102 may be automatically initiated so that reprinting results in the scanned image 202 likewise better representing the image 200.

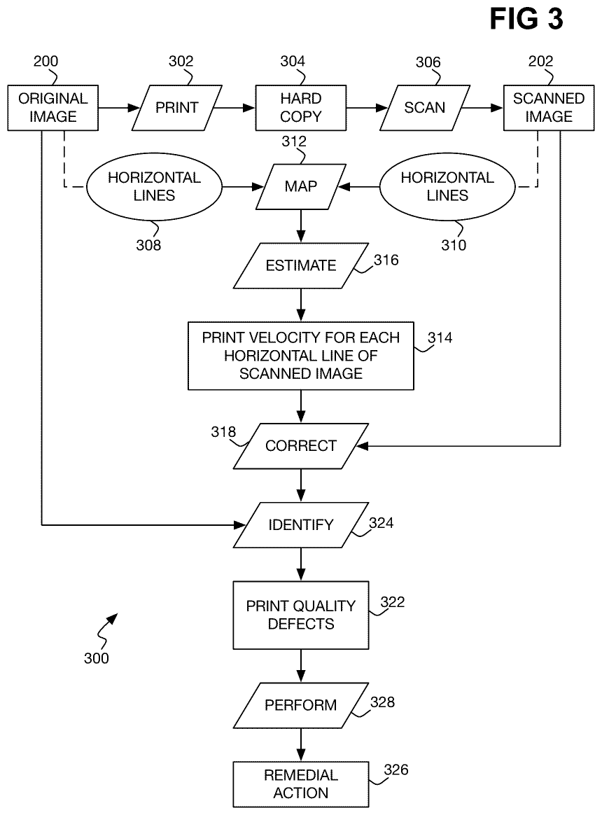

FIG. 4 shows an example process 400 for estimating print velocity at which an original image 200 was being printed when each row of pixels of a corresponding scanned image 202 was generated by scanning the hardcopy 304 of the original image 200. In the process 400, the horizontal lines 308 of the original image 200 and the horizontal lines 310 of the scanned image 202 each constitute an individual (i.e., single) row of pixels. The process 400 can be performed regardless of whether the original image 200 includes only graphical content (e.g., per FIG. 1C), only text content (e.g., per FIG. 1D), or both graphical and text content (e.g., per FIG. 1E).

If the original image 200 is a full-color image having color values for color components of a color space, then the original image 200 is first converted to grayscale (402). Similarly, if the scanned image 202 has color values for color components of a color space, it is first converted to grayscale as well (404). Either or both of the original image 200 and the scanned image 202 may already be in grayscale, however. For example, the scan hardware 104 may scan in grayscale, such that the scanned image 202 is grayscale regardless of whether the original image 200 is full-color or grayscale.

A horizontal projection 406 is calculated (408) for each row of pixels of the grayscale original image 200, yielding horizontal projections 406 for the rows of the original image 200. Likewise, a horizontal projection 410 is calculated (412) for each row of pixels of the grayscale scanned image 202, yielding horizontal projections 410 for the rows of the scanned image 202. A horizontal projection for a row 154 of pixels 152 is the sum of the grayscale values of the pixels 152 in that row 154. If there are X columns 156 of pixels 152, this means that the horizontal projection for each row 154 of pixels 152 is the sum of X respective pixels 152.

The horizontal projections 406 can be represented as a vector M=m[1], m[2], . . . , m[i], . . . , m[n] for an original image 200 having n rows of pixels, where the i-th row has the horizontal projection m[i]. The horizontal projections 410 can similarly be represented as a vector T=t[1], t[2], . . . , t[j], . . . , t[r] for a scanned image 202 having r rows of pixels, where the j-th row has the horizontal projection t[j].

A warping path 414 is generated (416) that maps the horizontal projections 406 for the rows of pixels of the original image 200 to the rows of pixels of the scanned image 202, such as by using dynamic time warping. A warping path W maps the elements of the vectors M and T to minimize the distance between them, where W is a sequence of grid points (i,j). The optimal path to identify the corresponding rows of pixels between the original image 200 and the scanned image 202 can be particularly calculated by the following equation.

$${D}_{min} ( {i}_{k} , {j}_{k} ) = {min}_{{i}_{k - 1} , {j}_{k - 1}} [ {D}_{min} ( {i}_{k - 1} , {j}_{k - 1} ) + d ( {i}_{k} , {j}_{k} \vert {i}_{k - 1} , {j}_{k - 1} ) ]$$

$${i}_{1} = 1 , {i}_{k} = p$$

$${j}_{1} = 1 , {j}_{k} = q$$

$${i}_{t - 1} \leq {i}_{t} , {j}_{t - 1} \leq {j}_{t}$$

$${i}_{t} - {i}_{t - 1} \leq 1 , j - {j}_{t - 1} \leq 1$$

Dynamic time warping is a technique that can identify the best corresponding relationship between the rows of pixels of the original image 200 and the rows of pixels of the scanned image 202. Dynamic time warping calculates an optimal match between two sequences with certain restrictions and rules. First, every index from the sequence M must be matched with one or more indices from the sequence T. Second, the first index from the sequence M must be matched with at least the first index from the sequence T, which in the equation is indicated by i₁=1, j₁=1.

Third, the last index from the sequence M must be matched with at least the last index from the sequence T, which in the equation is indicated by iₖ=p, jₖ=q. Fourth, the mapping of the indices from the sequence M to the indices from sequence T must be monotonically increasing, which in the equation is indicated by iₜ₋₁≤iₜ, jₜ₋₁≤jₜ and iₜ−iₜ₋₁≤1, j−jₜ₋₁≤1.

The optimal match is denoted by the match that satisfies all the restrictions and rules, and that has the minimal cost. The cost may be computed as the sum of absolute differences for each matched pair of indices, between their values, such as shown in the equation as to the objective function Dₘᵢₙ(iₖ,jₖ). This objective function is dynamic, and Dₘᵢₙ(iₖ,jₖ) is the total distance between m[1:iₖ] and t[1:jₖ] having the best alignment.

Similarly, as to Dₘᵢₙ(iₖ₋₁,jₖ₋₁), d(iₖ,jₖ|iₖ₋₁,jₖ₋₁) is the distance between the projection value m[iₖ] and the projection value t[jₖ] based on the previous index k−1. Because m[iₖ] and t[jₖ] are horizontal projections, the distance is calculated using |m[iₖ]|−|t[jₖ]|. In the objective function, each current index k optimal match result Dₘᵢₙ(iₖ,jₖ) is the minimum sum of the previous index k−1 optimal match result Dₘᵢₙ(iₖ₋₁,jₖ₋₁) plus the current index k distance d(iₖ,jₖ|iₖ₋₁,jₖ₋₁). The global minimum cost (i.e., the optimal match result) is obtained from all the possible paths.

A row index matrix 418 mapping the rows of pixels of the original image 200 to the rows of pixels of the scanned image 202 can then be constructed (420) based on (e.g., from) the warping path. In the row index matrix 418, a value of one is used to label the same row of pixels between the original image 200 and the scanned image 202. A vertical sum for each column of the row index matrix 418 can then be calculated to identify the number of rows of pixels of the scanned image 202 corresponding to each row of pixels in the original image 200. Construction of the row index matrix 418 can be considered as part of the mapping performed in 312 of FIG. 3.

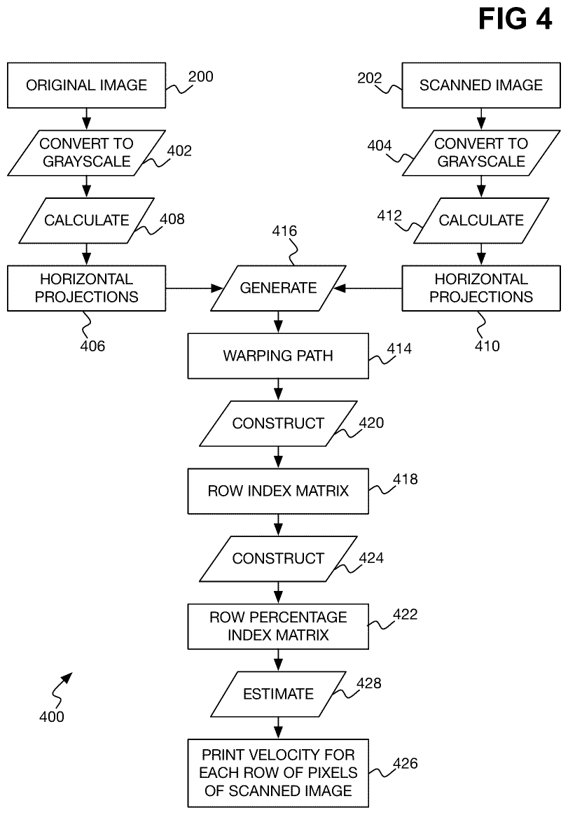

FIG. 5A shows an example row index matrix 418. The columns of the matrix 418 correspond to pixel rows 502 of the original image 200, whereas the rows of the matrix 418 correspond to pixel rows 504 of the scanned image 202. In the example, there are therefore 3,300 rows 502 of pixels in the original image 200, and 4,965 rows 504 of pixels in the scanned image 202. The value of an element at the intersection of a matrix column corresponding to a row 502 of the original image 200 and a matrix row corresponding to a row 504 of the scanned image 202 is one if the pixel row 504 of the scanned image 202 does not correspond to the pixel row 502 of the original image 200, and is otherwise zero.

For example, just the first pixel row 504 of the scanned image 202 corresponds to the first pixel row 502 of the original image 200. By comparison, both the third and fourth pixel rows 504 of the scanned image 202 correspond to the third pixel row 502 of the original image 200. Similarly, all three of the fourth, fifth, and sixth pixel rows 504 of the scanned image 202 correspond to the fourth pixel row 502 of the original image 200. In this respect, the fourth pixel row 504 of the scanned image 202 corresponds to both the third and fourth pixel rows 502 of the original image 200.

The vertical sum 506 for each column of the matrix 418 is the total number of pixel rows 504 of the scanned image 202 corresponding to the pixel row 502 of the original image 200 of the column in question. For example, for the column corresponding to the fourth row 502 of pixels of the original image 200, there are three corresponding rows 504 of pixels in the scanned image 202, such that the vertical sum 506 is three. As another example, for the column corresponding to the sixth pixel row 502 of the original image, there is just one corresponding pixel row 504 in the scanned image 202, such that the vertical sum is one.

Referring back to FIG. 4, a row percentage index matrix 422 is then constructed (424) based on (e.g., from) the row index matrix 418. Each element of the row percentage index matrix 422 is equal to the corresponding element of the row index matrix 418, divided by the vertical sum that has been calculated for that element. A horizontal sum for each row of the row percentage index matrix 422 can then be calculated. The horizontal sum for a pixel row 504 of the scanned image 202 corresponds to an estimated print velocity when the hardcopy 302 was scanned to generate that pixel row 504. Construction of the row percentage index matrix 422 can also be considered as part of the mapping performed in 312 of FIG. 3.

FIG. 5B shows an example row percentage index matrix 422 corresponding to the row index matrix 418 of FIG. 5A. The columns of the matrix 422 again correspond to the pixel rows 502 of the original image 200, with the rows of the matrix 422 again corresponding to the pixel rows 504 of the scanned image 202. The value of an element in the row percentage index matrix 422 at the intersection of a matrix column corresponding to a row 502 of the original image 200 and a matrix row corresponding to a row 504 of the scanned image 202 is the corresponding element of the row index matrix 418 divided by the vertical sum 506 for that element in FIG. 5A.

For example, the element in the row percentage index matrix 422 corresponding to the third pixel row 502 of the original image 200 and the third pixel row 504 of the scanned image 202 is 0.5. This is equal to the value of the element in the row index matrix 418 corresponding to the third row 502 of the original image 200 and the third row 504 of the scanned image 202, which is 1, divided by the vertical sum 506 for the third row 502 of the original image 200, which is 2.

As another example, the element in the row percentage index matrix 422 corresponding to the fourth pixel row 502 of the original image 200 and the sixth pixel row 504 of the scanned image 202 is (approximately) 0.33. This is (approximately) equal to the value of the element in the row index matrix 418 corresponding to the fourth row 502 of the original image 200 and the sixth row 504 of the scanned image 202, which is 1, divided by the vertical sum 506 for the row 502 of the original image 200, which is 3.

The horizontal sum 552 for each row of the row percentage index matrix 422 is the sum of the elements in that row. For example, the horizontal sum 552 for the matrix row corresponding to the fourth pixel row 504 of the scanned image 202 is 0.83, since there are two non-zero elements in this matrix row, 0.5 in the third matrix column and 0.33 in the fourth matrix column. As another example, the horizontal sum for the matrix row corresponding to the seventh pixel row 504 of the scanned image 202 is 1.5, since there are two non-zero elements in this matrix row, 0.5 in the fifth matrix column and 1 in the sixth matrix column.

The horizontal sum 552 for a pixel row 504 of the scanned image 202 corresponds to an estimated print velocity at which the hardcopy 302 of the original image 200 was being printed when the hardcopy 302 was scanned to generate that pixel row 504. A horizontal sum 552 for a pixel row 504 of the scanned image 202 equal to one means that the estimated print velocity for that row 504 was (roughly) equal to the constant scan rate of the scan hardware 104.

A horizontal sum 552 for a pixel row 504 greater than one means that the estimated print velocity for that row 504 was greater than the constant scan rate. A horizontal sum 552 for a pixel row 504 less than one means that the estimated print velocity for that row 504 was less than the constant scan rate. As depicted in FIG. 5B, the estimated print velocity can dramatically fluctuate between pixel rows 504, such as from 0.3 to 0.83 from the fifth to sixth pixel rows 504 and from 0.83 to 1.5 from the sixth to seventh pixel rows 504 of the scanned image 202.

Referring back to FIG. 4, the print velocity 426 for each row 504 of pixels of the scanned image 202 can thus be estimated (428) based on the row percentage index matrix 422. In one implementation, the print velocity 426 for a row 504 of pixels may be estimated as the horizontal sum 552 of that row 504, as has been described. However, because the estimated print velocity 426 can markedly fluctuate between pixel rows 504 as noted, the estimated print velocity 426 may be smoothed, such as by using a twice average 20 pixel filter in one implementation, such as when the scanned image 202 is scanned at 600 dots-per-inch (dpi). In case in which the scanned image 202 is scanned at 300 dpi, by comparison, a 10 pixel filter may be used as one example.

The described process 400 pertains to an original image 200 that includes only graphical content (e.g., per FIG. 1C), only text content (e.g., per FIG. 1D), or both graphical and text content (e.g., per FIG. 1E). Testing of an original image 200 that includes user-generated content that is not particularly constructed for print velocity estimation—as opposed to a test or calibration image that is—has demonstrated that the process 400 can accurately estimate print velocity 426.

In cases in which the original image 200 includes only text content (e.g., per FIG. 1D), or both graphical (and a sufficient amount of) text content (e.g., per FIG. 1E), another process may be employed to estimate print velocity 426. In the process 400, the horizontal lines 308 of the original image 200 and the horizontal lines 310 of the scanned image 202 are individual pixel rows 502 and 504, respectively. However, in another process, the horizontal lines 308 and 310 are individual intervals that each encompass rows of pixels corresponding to a line of text or whitespace between adjacent lines of text.

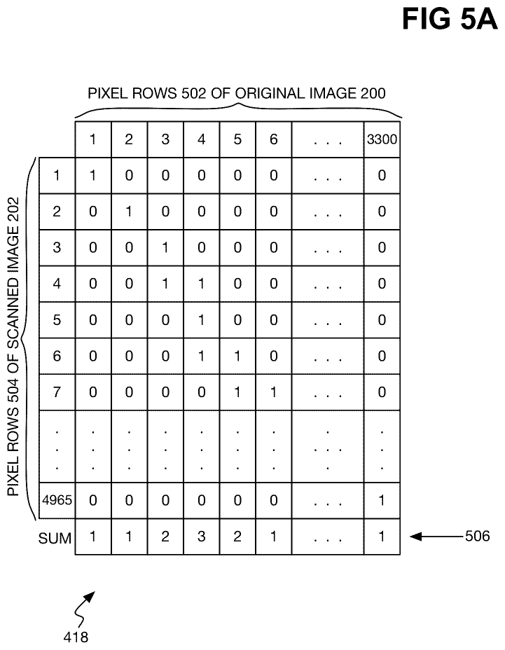

FIG. 6 shows an example original image 200 and an example corresponding scanned image 202 having such intervals. The original image 200 includes eight intervals 602A, 602B, 602C, 602D, 602E, 602F, 602G, and 602H corresponding to lines of text and which are collectively referred to as the intervals 602. The original image 200 also includes seven intervals 604A, 604B, 604C, 604D, 604E, 604F, and 604G corresponding to whitespace between adjacent lines of text and which are collectively referred to as the intervals 604.

Each interval 602 encompasses multiple rows of pixel encompassing a single line of text, and each interval 604 encompasses multiple rows of pixels encompassing whitespace between adjacent lines of text. In the example, each of the intervals 602 and 604 have the same height. This means that each of the intervals 602 and 604 encompasses the same number of pixel rows within the original image 200.

The scanned image 202 similarly includes eight intervals 606A, 606B, 606C, 606D, 606E, 606F, 606G, and 606H corresponding to lines of text and which are collectively referred to as the intervals 606. The scanned image 202 also similarly includes seven intervals 608A, 608B, 608C, 608D, 608E, 608F, and 608G corresponding to whitespace between adjacent lines of text and which are collectively referred to as the intervals 608.

Each interval 606 encompasses multiple rows of pixel encompassing a single line of text, and each interval 608 encompasses multiple rows of pixels encompassing whitespace between adjacent lines of text. Unlike the intervals 602 and 604, the intervals 606 and 608 do not have the same height. The height of each interval 602 and 604 is proportional to the number of pixel rows that it encompasses within the scanned image 202.

The number of intervals 602 in the original image 200 is equal to the number of intervals 606 in the scanned image 202, with each interval 602 corresponding to one interval 606 as shown. The number of intervals 604 in the original image 200 is likewise equal to the number of intervals 608 in the scanned image 202, with each interval 604 corresponding to one interval 608 as shown.

An interval 606 or 608 in the scanned image 202 that is equal in height to its corresponding interval 602 or 604 in the original image 200 means that the estimated print velocity for that interval 606 or 608 is (roughly) equal to the constant scan rate of the scan hardware 104. An interval 606 or 608 that is taller in height than its corresponding interval 602 or 604 means that the estimated print velocity for that interval 606 or 608 is slower than the constant scan rate. An interval 606 or 608 that is shorter in height that its corresponding interval 602 or 604 means that the estimated print velocity for that interval 606 or 608 is faster than the constant scan rate.

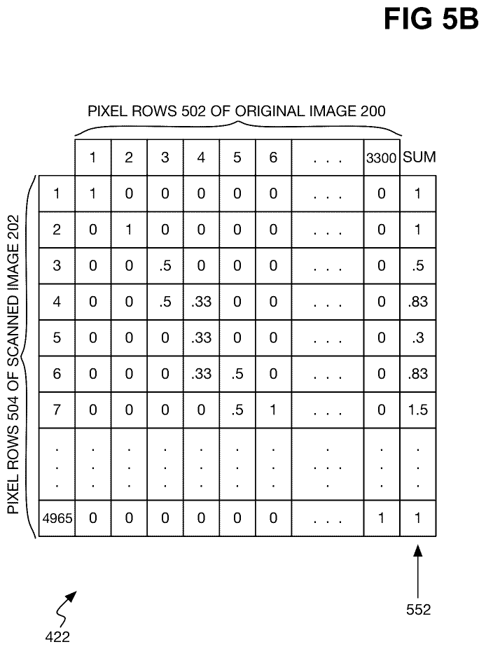

FIG. 7 shows an example process 700 for estimating print velocity at which an original image 200 was being printed when the rows of pixels of each interval 606 and 608 of a corresponding scanned image 202 was generated by scanning the hardcopy 304 of the original image 200. In the process 700, therefore, the horizontal lines 308 of the original image 200 each constitute an interval 602 or 604, and the horizontal lines 310 of the scanned image 202 each constitute an interval 606 or 608. The process 400 can be performed if the original image 200 includes only text content (e.g., per FIG. 1D), or both graphical and text content (e.g., per FIG. 1E).

As in the process 400, if the original image 200 is a full-color image, then it is first converted to grayscale (702), and similarly, if the scanned image 202 has color values for color components of a color space, then it is first converted to grayscale (704). The grayscale original image 200 is also binarized to black-and-white (706), as is the grayscale scanned image 202 (708). For example, grayscale pixel values greater than a threshold may be set to 1, corresponding to black, and grayscale pixel values less than or equal to the threshold may be set to 0, corresponding to white.

Any non-textual graphical content is removed (710) from the black-and-white (binarized) original image 200, and similarly any non-textual graphical content is removed (712) from the black-and-white (binarized) scanned image 202. Non-textual (i.e., graphical) content can be removed using connected component analysis (CCA). A CCA algorithm is applied to each of the original and scanned images 200 and 202. Connected components having an area in pixels greater than a threshold are considered as corresponding to non-textual graphical content and are removed by setting the values of their pixels to 0 in the image 200 or 202 in question.

Horizontal projections 714 for the rows of pixels of the binarized original image 200 from which any non-graphical content has been removed are calculated (716). Similarly, horizontal projections 718 for the rows of pixels of the binarized scanned image 202 from which any non-graphical content has been removed are calculated (720). Similar to as in the process 400, a horizontal projection for a row of pixels is the sum of the binary values of the pixels in that row. If the original image 200 and the scanned image 202 each have X columns of pixels, this means that the horizontal projection 714 and 718 for each row of pixels in the images 202 and 202 may be between 0 and X, since each pixel has a binary value of 0 or 1.

A 0-1, or binary, plot 720 is constructed (722) for the original image 200 based on (e.g., from) the horizontal projections 714. Similarly, a 0-1, or binary, plot 723 is constructed (724) for the scanned image 202 based on (e.g., from) the horizontal projections 718. The 0-1 plot 720 has a number of entries corresponding to the number of horizontal projections 714, and thus to the number of pixel rows of the original image 200. The 0-1 plot 723 likewise has a number of entries corresponding to the number of horizontal projections 718, and thus to the number of pixel rows of the scanned image 202.

Each entry within the 0-1 plot 720 for the original image 200 is specifically set to 0 if the corresponding horizontal projection 714 is less than or equal to a threshold, and is set to 1 if the corresponding horizontal projection 714 is greater than the threshold. Each entry within the 0-1 plot 723 for the scanned image 202 similarly is specifically set to 0 if the corresponding horizontal projection 718 is less than or equal to the threshold, and is set to 1 if the corresponding horizontal projection 718 is greater than the threshold.

The entries within the 0-1 plots 720 and 722 having values of 1 correspond to rows of pixels in their respective images 200 and 202 that are more likely to be part of lines of text. By comparison, the entries within the 0-1 plots 720 and 723 having values of 0 correspond to rows of pixels in their respective images 200 and 202 that are likely to be part of whitespace.

Therefore, the intervals 726 within the original image 200 can be labeled (728) or identified from the 0-1 plot 720. The intervals 726 include both the intervals 602 and 604 of FIG. 6 that have been described. The intervals 730 within the scanned image 202 can be likewise labeled (732) or identified from the 0-1 plot 723. The intervals 730 include both the intervals 606 and 608 of FIG. 6 that have been described.

For example, if an image has Y rows, then the corresponding 0-1 plot has Y entries from a first entry y=0 to a last entry y=Y−1. Each contiguous group of entries having the same value is assigned to the same interval. In one implementation, intervals are not labeled until the first entry with a value of 1 is identified, and no interval is labeled past the last entry with a value of 1.

For example, the first ten y=0 . . . 9 entries may have a value of 0, and therefore are not considered. The next fifteen entries y=10 . . . 24 may have a value of 1, and therefore are labeled as an interval corresponding to a line of text. The next fifteen entries y=25 . . . 39 after that may have a value of 0, and therefore are labeled as an interval corresponding to whitespace between adjacent lines of text. The following fifteen entries y=40 . . . 54 may have a value of 1, and therefore are labeled as an interval corresponding to a line of text.

The last line y=Y−15 that has a value of 1 may be part of a last interval corresponding to a line of text that encompasses lines y=Y−29 . . . Y−15. Therefore, in one implementation, subsequent lines of text y=Y−14 . . . Y that have values of 0 may not be considered. (It is noted that in another implementation, the first entries within the 0-1 plot having a value of 0, and the entries having a value of 0 past the last entry having a value of 1, may be labeled as intervals, however.)

If the number of intervals 726 identified in the original image 200 does not equal the number of intervals 730 identified in the scanned image 202 (734), then the process 700 is aborted (736). This is because in the process of 700, the number of intervals 726 has to equal the number of intervals 726 to properly estimate print velocity. In the case in which the process 700 is aborted, the process 400 may instead be employed for print velocity estimation.

For each interval 726 of the original image 200, a corresponding interval 730 in the scanned image is identified or specified (738). Each interval 730 is mapped to one interval 726, and because there are equal numbers of intervals 726 and 730, this means that each interval 726 is mapped to one interval 730. Identification of corresponding pairs of intervals 726 and 730 in 738 can be considered as part of the mapping performed in 312 of FIG. 3.

For each interval 726 and 730, the starting and ending pixel rows in its respective image 200 or 202 are also identified or specified (742), which define the position of the interval 726 or 730 in question. For example, the original image 200 may have n rows of pixels and g intervals 726. Therefore, each interval i=0 . . . g−1 in the original image 200 has a starting pixel row MSᵢ=0 . . . n−1 and an ending pixel row MEᵢ=0 . . . n−1, where MEᵢ>MSᵢ, and for every interval i>0, MEᵢ=MSᵢ₋₁+1. That is, the starting pixel row of every interval 726 other than the first interval 726 is the pixel row immediately after the ending pixel row of the prior interval 726.

Similarly, the scanned image 202 may have r rows of pixels, and also has g intervals 730. Therefore, each interval i=0 . . . g−1 in the scanned image 202 has a starting pixel row TSᵢ=0 . . . r−1 and an ending pixel row TEᵢ=0 . . . r−1, where TEᵢ>TSᵢ, and for every interval i>0, TEᵢ=TSᵢ₋₁+1. That is, the starting pixel row of every interval 730 other than the first interval 730 is the pixel row immediately after the ending pixel row of the prior interval 730.

The print velocity 746 at which the hardcopy 304 of the original image 200 was being printed when the pixel rows of each interval 730 of the scanned image 202 were being generated can then be estimated (748). The estimated print velocity 746 for each interval i=0 . . . g−1 in the scanned image 202 is calculated as

$$[ \frac{{ME}_{i} - {MS}_{i}}{{TE}_{i} - {TS}_{i}} ] .$$

That is, the print velocity 746 for each interval 730 of the scanned image 202 is estimated as the pixel height of the corresponding interval 726 in the original image 200 divided by the pixel height of the interval 730 in question. The estimated print velocity 746 may be smoothed, such as by using a 30 kernel size average fluctuation.

The printed velocity 426 for each row of pixels of the scanned image 202 can then be calculated based on (e.g., from) the print velocity 746 of the interval 730 encompassing the row of pixels in question (752). Specifically, the print velocity 426 of a row of pixels of the scanned image 202 can be set to the print velocity 426 that has been estimated for the interval 730 including that row of pixels. As in the process 400, the estimated print velocity 426 may be smoothed, such as by using a twice average 20 pixel filter in one implementation.

The described process 700 pertains to an original image 200 that includes only text content (e.g., per FIG. 1D), or both graphical and (a sufficient amount of) text content (e.g., per FIG. 1E). Testing of an original image 200 that includes user-generated textual context that is not particularly constructed for print velocity estimation—as opposed to a test or calibration image that is—has demonstrated that the process 700 can accurate estimate print velocity 428.

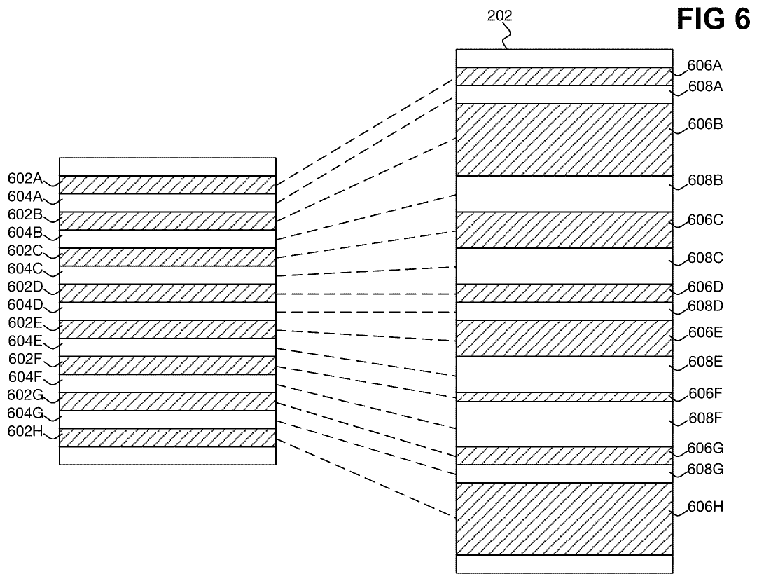

FIG. 8 shows an example non-transitory computer-readable data storage medium 800 storing program code 802 executable by a processor to perform processing. The processing includes receiving an original image 200 and a scanned image 202 of a hardcopy 304 of the original image 200 (804). The original image 200 and the scanned image 202 having horizontal lines 308 and 310, respectively.

The original image 200 is printed by print hardware 102 at a varying print velocity 428 to generate the printed hardcopy 304, and the printed hardcopy 304 is scanned by scan hardware 104 in-line with the print hardware 102 at a constant scan rate to generate the scanned image 202. The processing includes correcting the scanned image 202, based on the print velocity 428 at which the original image 200 was printed for each horizontal line 310 of the scanned image 202 (806).

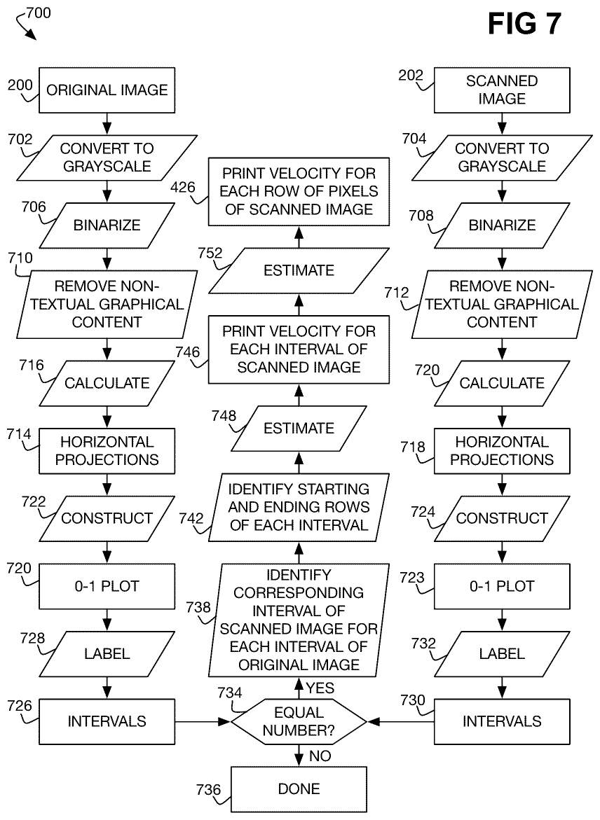

FIG. 9 shows an example electronic device 900. The electronic device 900 includes a processor 902 and a memory 904 storing program code 906. In one implementation, the electronic device may be a computing device, such as a computer directly connected to the printing device 100 or a cloud server communicatively connected to the printing device 100. In another, the electronic device 900 may be the printing device 100, and thus may include the print hardware 102 and the scan hardware 104. The program code 906 is executable by the processor 902 to receive an original image 200 and a scanned image 202 of a hardcopy 304 of the original image 200 (908).

The original image 200 and the scanned image 202 respectively have rows of pixels. The original image 200 is printed by the print hardware 102 at a varying print velocity 428 to generate the printed hardcopy 304, and the printed hardcopy 304 is scanned by the scan hardware 104 in-line with the print hardware 102 at a constant scan rate to generate the scanned image 202. The program code 906 is executable by the processor 902 to correct the scanned image 202, based on the print velocity 428 at which the original image 200 was printed for each row of pixels of the scanned image 202 (910).

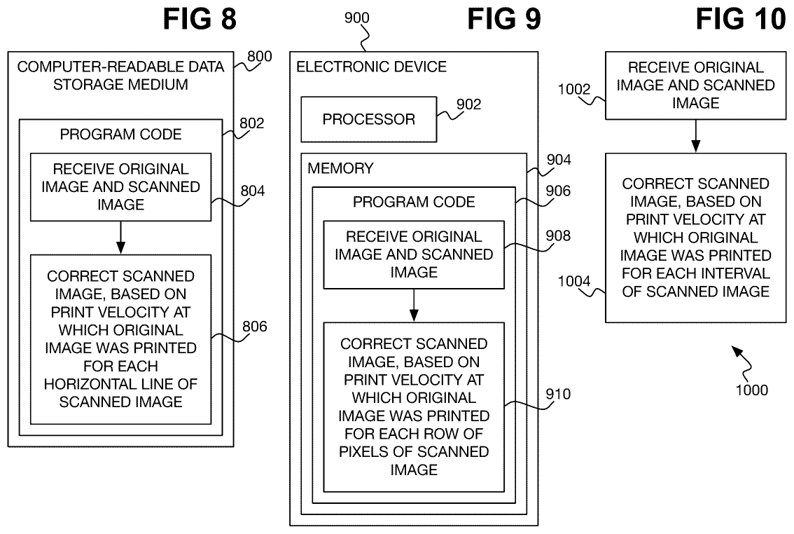

FIG. 10 shows an example method 1000. The method 1000 may be performed by a processor, such as the processor 902 of the electronic device 900. The method 1000 includes receiving an original image 200 and a scanned image 202 of a hardcopy 304 of the original image 200 (1002). The original image 200 and the scanned image 202 respectively have intervals 726 and 730 that each correspond to a line of text or to whitespace between adjacent lines of text.

The original image 200 is printed by print hardware 102 at a varying print velocity 428 to generate the printed hardcopy 304, and the printed hardcopy 304 is scanned by scan hardware 104 in-line with the print hardware 304 at a constant scan rate to generate the scanned image 202. The method 1000 includes correcting the scanned image 202, based on a print velocity 746 at which the original image 200 was printed for each interval 730 of the scanned image 202 (1004).

Techniques have been described for estimating the print velocity at which a hardcopy 304 of an original image 200 was being printed when each horizontal line 310 of the scanned image 202 was generated by scanning the printed hardcopy 304. The print velocity estimation techniques described herein have been shown to be accurate even for original images 200 that include user-generated content that has not been constructed for print velocity estimation purposes. The scanned image 202 can be corrected to compensate for omitted and/or redundant rows of pixels within the image 202, providing for improved print defect identification using the scanned image 202.

We claim:

1. A non-transitory computer-readable data storage medium storing program code executable by a processor to perform processing comprising:
receiving an original image and a scanned image of a hardcopy of the original image, each of the original image and the scanned image having a plurality of horizontal lines,
wherein the original image is printed by print hardware at a varying print velocity to generate the printed hardcopy, and the printed hardcopy is scanned by scan hardware in-line with the print hardware at a constant scan rate to generate the scanned image; and
correcting the scanned image, based on a print velocity at which the original image was printed for each horizontal line of the scanned image.

2. The non-transitory computer-readable medium of claim 1, wherein the original image comprises user-generated content that is not constructed for print velocity estimation.

3. The non-transitory computer-readable medium of claim 1, wherein the processing further comprises:
mapping the horizontal lines of the original image to the horizontal lines of the scanned image; and
for each horizontal line of the scanned image, estimating the print velocity at which the original image was printed, based on mapping of the horizontal lines of the original image to the horizontal lines of the scanned image.

4. The non-transitory computer-readable medium of claim 3, wherein the scanned image is corrected to compensate for either or both of redundant rows of pixels and missing rows of pixels in the scanned image, based on the print velocity that has been estimated for each horizontal line of the scanned image.

5. The non-transitory computer-readable medium of claim 4, wherein the processing further comprises:
identifying print quality defects in the printed hardcopy of the original image, based on a comparison of the scanned image as corrected to the original image; and performing a remedial action in relation to the print hardware, based on the print quality defects that have been identified.

6. The non-transitory computer-readable medium of claim 3, wherein the original image and the scanned image each have a plurality of rows of pixels, the processing further comprises:
generating a horizontal projection for each row of pixels of the original image and for each row of pixels of the scanned image, yielding a plurality of horizontal projections for the rows of pixels of the original image and a plurality of horizontal projections for the rows of pixels of the scanned image,
wherein the horizontal lines of the original image are mapped to the horizontal lines of the scanned image based on the horizontal projections for the rows of pixels of the original image and the horizontal projections for the rows of pixels of the scanned image.

7. The non-transitory computer-readable medium of claim 6, wherein the processing further comprises:
converting each of the original image and the scanned image to grayscale,
wherein the horizontal projection is generated for each row of pixels of the original image and for each row of pixels of the scanned image as converted to grayscale.

8. The non-transitory computer-readable medium of claim 6, wherein each horizontal line of the original image and each horizontal line of the scanned image comprises a single row of the rows of pixels,
and wherein mapping the horizontal lines of the original image to the horizontal lines of the scanned image comprises:
generating a warping path mapping the horizontal projections for the rows of pixels of the original image to the horizontal projections for the rows of pixels of the scanned image, using dynamic time warping; and
constructing a row index matrix mapping the rows of pixels of the original image to the rows of pixels of the scanned image, based on the warping path.

9. The non-transitory computer-readable medium of claim 8, wherein the processing further comprises:
constructing a row percentage index matrix identifying an approximate print velocity for each row of pixels of the scanned image, based on the row index matrix,
wherein, for each horizontal line of the scanned image, the print velocity is estimated based on the row percentage index matrix.

10. The non-transitory computer-readable medium of claim 6, wherein the horizontal lines of the original and scanned images comprise a plurality of intervals, the processing further comprising:
labeling each interval of the original image, based on the horizontal projections for the rows of pixels of the original image; and
labeling each interval of the scanned image, based on the horizontal projections for the rows of pixels of the scanned image,
wherein each interval encompasses multiple rows of pixels corresponding to a line of text or to whitespace between adjacent lines of text,
and wherein mapping the horizontal lines of the original image to the horizontal lines of the scanned image comprises:
for each interval of the original image, identifying a single corresponding interval of the scanned image.

11. The non-transitory computer-readable medium of claim 10, wherein the processing further comprises:
for each interval of the original image, identifying starting and ending rows of pixels specifying a position of the interval in the original image; and
for each interval of the scanned image, identifying starting and ending rows of pixels specifying a position of the interval in the scanned image,
wherein, for each interval of the scanned image, the print velocity is estimated based on the starting and ending rows of pixels for the interval of the scanned image and the starting and ending rows of pixels for the interval of the original image to which the interval of the scanned image corresponds.

12. The non-transitory computer-readable medium of claim 10, wherein the processing further comprises:
converting each of the original image and the scanned image to grayscale;
binarizing each of the original image and the scanned image as converted to grayscale; and
removing any non-textual graphical content from the each of the original image and the scanned image as binarized,
wherein the horizontal projection is generated for each horizontal line of the original image and for each horizontal line of the scanned image from which any non-textual graphical content has been removed.

13. An electronic device comprising:
a processor; and
a memory storing program code executable by the processor to:
receive an original image and a scanned image of a hardcopy of the original image, each of the original image and the scanned image having a plurality of rows of pixels,
wherein the original image is printed by print hardware at a varying print velocity to generate the printed hardcopy, and the printed hardcopy is scanned by scan hardware in-line with the print hardware at a constant scan rate to generate the scanned image; and
correct the scanned image, based on a print velocity at which the original image was printed for each row of pixels of the scanned image.

14. The electronic device of claim 13, wherein the electronic device is a printing device comprising the print hardware and the scan hardware.

15. A method comprising:
receiving, by a processor, an original image and a scanned image of a hardcopy of the original image, each of the original image and the scanned image having a plurality of intervals that each correspond to a line of text or to whitespace between adjacent lines of text,
wherein the original image is printed by print hardware at a varying print velocity to generate the printed hardcopy, and the printed hardcopy is scanned by scan hardware in-line with the print hardware at a constant scan rate to generate the scanned image; and
correcting the scanned image, by the processor, based on a print velocity at which the original image was printed for each interval of the scanned image.
